(19) United States
(12) Patent Application Publication
(10) Pub. No.: US 2012/0215718 A1
(43) Pub. Date: Aug. 23, 2012

(54) Computer Implemented System and Method for Aggregating, Analyzing and Distributing Information Corresponding to Retirement Plans

(76) Inventor: Rajagopal Sitaram, Chennai (IN)

(21) Appl. No.: 13/398,048

(22) Filed: Feb. 16, 2012

(30) Foreign Application Priority Data
Feb. 17, 2011 (IN) 454/CHE/2011

(51) Int. Cl. G06Q 40/06

(52) U.S. Cl. 705/36 R

(57) ABSTRACT

A computer implemented system and method for aggregating, analyzing, and distributing information corresponding to retirement plans offered to users have been disclosed. The system includes a database adapted to store at least authentication credentials and payroll information corresponding to users. The system includes a configuration module adapted to configure the retirement plans based on pre defined rules. The retirement plans are offered to users subsequent to determining, based on the payroll information corresponding to users, whether the users are eligible for a retirement plan. The users who have been identified as eligible are automatically enrolled onto the retirement plan via an enrollment module. The system also enables the users to initiate investment transfers including transfer of investments between various plans, reallocation of investments within the same plan and rebalancing of investments within the same plan.

### FIELD OF THE DISCLOSURE

The present disclosure relates to the field of data management.

Particularly, this disclosure relates to the field of facilitating efficient gathering, analysis, aggregation and dissemination of data.

### BACKGROUND

Certain percentage of the total workforce retires every year and a substantial number of people inch closer to retirement with passage of every year. Most of the working professionals tend to adopt an aggressive approach towards obtaining retirement benefit plans when they are on the verge on taking a retirement from their professional careers.

When an employer makes an annual contribution for a particular employee under the definite retirement contribution plan, the retirement solutions provider initiates the processing of retirement plan. Normally the process of obtaining a retirement plan includes a number of procedural steps which are carried out by the retirement solution provider.

Given below are some of the factors that are responsible for making the task of gathering, analysis, aggregation and dissemination of data cumbersome and time consuming:

1. Lack of process automation: Lack or absence of process automation leads to decreased productivity. For example, the process of enrolling the employees for a new retirement plan, employee registration can be carried out in two ways. Eligible employees can be either asked to register themselves to the newly formed retirement plan or the retirement plan provider or sponsors (designated employees of a sponsoring organization) can choose to upload a single file with the necessary details of all eligible participants. Making use of the latter not only saves time but also renders the process accurate.
2. Lack of integration with other software products and services: Lack of integration and synchronization measures can render a system to be ineffective and inefficient. An efficient software system needs to work in close synchronization with other products already available at consumer's end. Absence of synchronization and integration features will prevent the integration of the software system with the existing systems thereby rendering it ineffective.
3. Lack of customization: customizing the business rules underlying the implementation of any software system is an arduous task for the end users. Most of the data management software systems do not allow the users to easily customize the software system as per their needs.
4. Inability to handle large volume implementations: As the number of participants increases, the time taken for processes to execute can increase exponentially. An effective software system must incorporate performance enhancement tools that can handle large volumes of information without sacrificing on time. Inability to handle larger volumes of data might render a software system to be inefficient.
5. Lack of role-based access control rights: Prior art systems failed to provide role based access rights to the users of the software system. Lack of role based access rights makes privileged data available to even those users who would not require the privileged data for the purpose of carrying out their work. Making privileged and confidential data available to every employee increases the chances of data loss due to former employee sabotages.
6. Lack of dashboard based approach: A major feature unavailable in software products available in today's market is the ability to get a snapshot of the entire book-of-business. A software system, in order to be efficient and effective in providing the services needs to address this issue. After logging into the software system, the users should be able to see a list of things-to-do that are organized in the order of priority. Additionally, the users should also be allowed to directly navigate to the pages that host the relevant task. The inclusion of such a feature would save time and effort that is currently spent in navigating (sometimes through complex flows) through different pages before finally arriving at the target destination page.

To overcome the disadvantages associated with the prior art systems, the present disclosure proposes a system which:
implements a web based self service platform;
captures the necessary information at the source without loosing the control over the process of capturing the information;
abstains from stitching the individual data sets together;
provides highly automated business processes;
provides customizable plan templates and customizable business work flow structures;
provides role based access control rights;
offers services which can be deployed at separate, remotely located servers;
ensures data concurrency by isolating the transactions performed on the stored data;
makes use of caching to ensure that the data is stored as close as possible to the data consumer;

### OBJECTS

Some of the objects of the present disclosure, which at least one embodiment herein satisfy are as follows:

It is an object of the present disclosure to provide a system that implements a web based self service platform.

Another object of the present disclosure is to provide a system that captures the necessary information at the source without losing control over the process of capturing the information.

Yet another object of the present disclosure is to provide a system that abstains from stitching the individual data sets together.

Still further object of the present disclosure is to provide a system that provides highly automated business processes.

Another object of the present disclosure is to provide a system that incorporates a dashboard based approach.

Still further object of the present disclosure is to provide a system that provides customizable plan templates and business work flow structures.

Still further object of the present disclosure is to provide a system that offers services which can be deployed at separate, remotely located servers.

Another object of the present disclosure is to provide a system that ensures data concurrency by isolating the transactions performed on the stored data.

Other objects and advantages of the present disclosure will be more apparent from the following description when read in conjunction with the accompanying figures, which are not intended to limit the scope of the present disclosure.

### SUMMARY

In accordance with the present disclosure, there is provided a computer implemented system for aggregating, analyzing, and distributing information corresponding to retirement plans offered to users.

The system, in accordance with the present disclosure includes a database adapted to store the information corresponding to users, wherein the information includes at least authentication credentials and payroll information.

Typically, in accordance with the present disclosure, the system further includes a configuration module having pre defined rules and adapted to configure the retirement plans and associate the pre defined rules with the retirement plans.

Typically, in accordance with the present disclosure, the system further includes a payroll module adapted to receive the payroll information, the payroll module having customizable validation rules for validating the payroll information, the payroll module adapted to identify and report inconsistencies in received payroll information.

The payroll module, in accordance with the present disclosure includes a profile creator adapted to create payroll profiles corresponding to each of the users.

Typically, in accordance with the present disclosure, the system further includes eligibility module having customizable eligibility rules for identifying and listing users eligible for being enrolled in at least one retirement plan, the eligibility module further adapted to automatically send a notification to listed eligible users inviting them to get enrolled into the retirement plan.

Typically, in accordance with the present disclosure, the system further includes enrollment module adapted to automatically enroll the eligible users into at least one retirement plan.

Typically, in accordance with the present disclosure, the system further includes transfer module adapted to enable the users to initiate investment transfer selected from the group of investment transfers consisting of transfer of investments between various plans, reallocation of investments within the same plan and rebalancing of investments within the same plan.

Typically, in accordance with the present disclosure, the system further includes updating means adapted to periodically update the payroll profiles corresponding to the users, the updating means further adapted to facilitate modification of at least beneficiary lists corresponding to retirement plans.

Typically, in accordance with the present disclosure, the database is further adapted to store at least the pre defined configuration rules, eligibility rules, list of eligible users, employee details and user investment details.

Typically, in accordance with the present disclosure, the eligibility module is further adapted to generate summary reports having at least the payroll details corresponding to eligible users, and detailed reports, the eligibility module further adapted to interlink the summary reports with said detailed reports.

Typically, in accordance with the present disclosure, the enrollment module is adapted to automatically transmit a personalized enrollment confirmation to the users enrolled into the retirement plans.

Typically, in accordance with the present disclosure, the system includes a user interface adapted to display the items selected from the group of items consisting of at least payroll profiles, beneficiary lists, employee details, user account summary, investment details, transaction history, retirement plan details, contribution details, retirement plan wise investment details and performance of the investment for a particular plan.

Typically, in accordance with the present disclosure, the system further includes authentication means co-operating with said database and having pre defined authentication rules and adapted to perform certificate based authentication to verify authentication credentials of the users.

In accordance with the present disclosure, there is provided a method for aggregating, analyzing, and distributing information corresponding to retirement plans offered to users. The method in accordance with the present disclosure includes the following steps:

storing the information corresponding to users, wherein the information includes at least authentication credentials and payroll information corresponding to said users;

associating pre defined rules with the retirement plans and configuring said retirement plans in accordance with the pre defined rules;

receiving the payroll information, validating the payroll information based on customizable validation rules and identifying and reporting the inconsistencies in the received payroll information;

identifying and listing, based on customizable eligibility rules, users eligible for being enrolled to at least one retirement plan and automatically sending a notification to the listed eligible users inviting them to get enrolled into the retirement plan;

automatically enrolling the eligible users into at least one retirement plan; and

enabling said users to initiate investment transfer selected from the group of investment transfers consisting of transfer of investments between various plans, reallocation of investments within the same plan and rebalancing of investments within the same plan.

Typically, in accordance with the present disclosure, the step of storing the information corresponding to users in an encrypted format further includes the step of storing at least pre defined configuration rules, eligibility rules, list of eligible users, employee details and user investment details.

Typically, in accordance with the present disclosure, the step of receiving the payroll information further includes the step of creating payroll profiles corresponding to each of the users.

Typically, in accordance with the present disclosure, the step of identifying and listing, based on customizable eligibility rules, users eligible for being enrolled to at least one retirement plan further includes the step of generating interlinked summary reports and detailed reports corresponding to the users.

Typically, in accordance with the present disclosure, the step of automatically enrolling the eligible users further includes the step of automatically transmitting a personalized enrollment confirmation to the users enrolled onto the retirement plan.

Typically, in accordance with the present disclosure, method for aggregating, analyzing, and distributing information corresponding to retirement plans offered to users further includes the steps of optionally updating the payroll profiles corresponding to the users and optionally modifying the beneficiary lists corresponding to said retirement plans enrolled onto by the users.

Typically, in accordance with the present disclosure, method for aggregating, analyzing, and distributing information corresponding to retirement plans offered to users further includes the step of performing certificate based authentication to verify authentication credentials of the users.

### BRIEF DESCRIPTION OF THE ACCOMPANYING DRAWINGS

The present disclosure will now be described with reference to the non-limiting, accompanying drawings, in which:

FIG. 1 illustrates a schematic representation of a system for aggregating, analyzing, and distributing information corresponding to retirement plans offered to users in accordance with the present disclosure;

FIG. 2 illustrates a flowchart corresponding a method of aggregating, analyzing, and distributing information corresponding to retirement plans offered to users in accordance with the present disclosure; and

FIG. 3 illustrates a schematic representation of the architecture of the system for aggregating, analyzing, and distributing information corresponding to retirement plans offered to users.

### DETAILED DESCRIPTION OF THE ACCOMPANYING DRAWINGS

The present disclosure will now be described with reference to the accompanying drawings which do not limit the scope and ambit of the disclosure. The description provided is purely by way of example and illustration.

The embodiments herein and the various features and advantageous details thereof are explained with reference to the non-limiting embodiments in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

To overcome the difficulties associated with effective aggregating, analyzing, and distributing information corresponding to retirement plans, the present disclosure proposes a system that treats the steps involved in issuing a retirement plan to the users as a single cycle of steps and provides for an effective collaboration between all the stakeholders involved in the process of providing retirement solutions. By treating the steps involved in providing a retirement plan as a single cycle of steps and by ensuring effective collaboration between all the stakeholders involved in the process of providing a retirement solution, the system of the present disclosure provides an efficient and effective system and method for aggregating, analyzing, and distributing information corresponding to retirement plans.

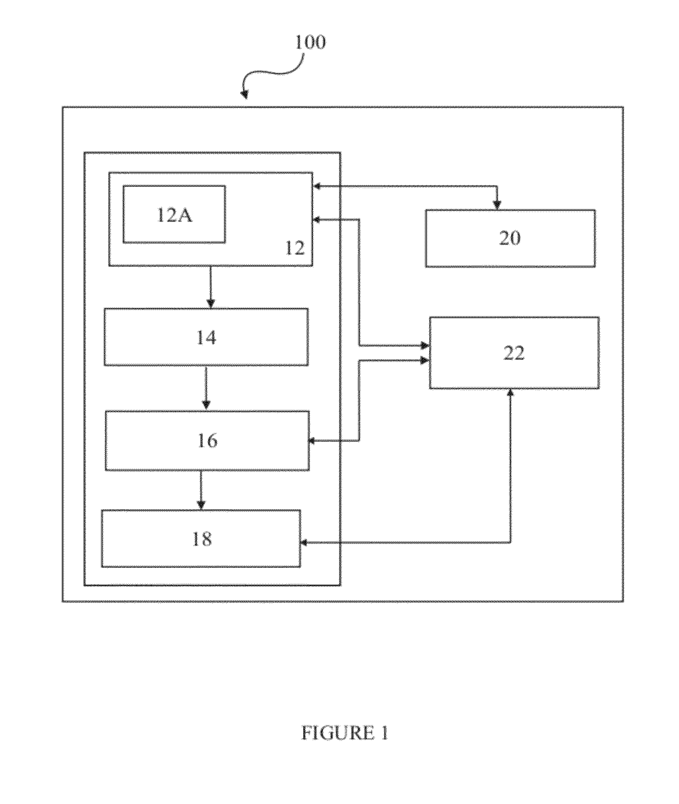

Referring to FIG. 1, there is shown a system that facilities effective and efficient aggregating, analyzing, and distributing information corresponding to retirement plans offered to users. In this specification, the term “user” refers to the users who have enrolled onto at least one retirement plan provided through the system 100. The system 100, in accordance with the present disclosure includes configuration module 10 having pre defined rules and adapted to configure the retirement plans to be made available to users and associate the pre defined rules with said retirement plans. The plan administrators/sponsors make the retirement plans configured by the configuration means 10 available to users. The system 100, in accordance with the present disclosure includes payroll module denoted by the reference numeral 12. The payroll module 12 is utilized by retirement plan administrators or sponsors to upload the payroll details corresponding to every user who wishes to obtain a retirement plan. The data entered by retirement plan administrators or sponsors using the payroll module 12 includes, but is not restricted to hours of service of a user, compensations provided by the employer, loan obtained by the user, monetary contributions from the user and the like. The data entered by retirement plan administrators or sponsors is validated by the payroll module 12 using customizable validation rules. The payroll module 12 includes a profile creator 12A which is adapted to create payroll profiles corresponding to the users by making use of the information provided to the payroll module 12 by retirement plan sponsors/administrators. The payroll module 12 also cooperates with a user interface (not shown in figures) that reports the occurrence of errors in submitted data, to the concerned retirement plan administrator or sponsor. The payroll module 12 further includes an updating means 12B which provides the retirement plan administrator or sponsor with the option of editing and updating the payroll information corresponding to users.

The payroll module 12, using the profile creator means 12A creates individual payroll profiles. The payroll module 12 is further adapted to carry out periodic updates on the created profiles in order to ensure accuracy of data. The predetermined verification rules utilized by the payroll module 12 are flexible and can be customized by the retirement plan administrator or sponsors depending upon their needs. The profiles created by the profile creator 12A can be transferred on to a remote server using well known methodologies including UI (User Interface) based upload and FTP (File Transfer Protocol) based upload. The payroll module 12 provides the retirement plan administrator or sponsors with the option of uploading the profiles on a one on one basis. The retirement plan administrator or sponsors need not have to wait until all the profiles are generated. As soon as a profile is generated, the payroll module 12 provides the retirement plan administrator or sponsors with the option of upload the profile onto a remote server. Alternately, the payroll module 12 also provides the retirement plan administrators or sponsors with the option of customizing the format of the payroll profile. The payroll module 12 also takes into consideration certain schedule details including but not restricted to retirement plan start date, retirement plan end date, retirement plan cutoff date and the like while creating the payroll profiles corresponding to users.

The system 10, in accordance with the present disclosure further includes an eligibility module denoted by the reference numeral 14. The eligibility module 14 cooperates with the payroll module 12 to receive the generated payroll profiles that correspond to the users willing to avail at least one retirement plan. The eligibility module 14 is adapted to identify and list the users who are eligible for a retirement plan. The identification and listing of eligible users is conducted by the eligibility module 14 based on the analysis of the respective payroll profiles. The users identified and listed by the eligibility module are subsequently invited to obtain the concerned retirement plan. The eligibility module 14 provides the option of sending either a group invite thereby inviting all the eligible users through a single invitation or sending separate invitations to individual users. The eligibility module 14, in accordance with the present disclosure is further adapted to generate summary reports and detailed reports wherein the summary reports created by the eligibility module 14 include at least the payroll details corresponding to eligible users. The summary reports created by the eligibility module 14 are linked with detailed reports which contain detailed information about the user and the retirement plans the user has enrolled onto.

The system 10, in accordance with the present disclosure further includes an enrollment module denoted by the reference numeral 16. The enrollment module 16 cooperates with the eligibility module 14 to receive the list of users who are eligible for at least one retirement plan. The enrollment module 16 provides the identified and listed users with the option of enrolling to the available retirement plans. The users who enroll to a particular retirement plan using the enrollment module 16 are treated as participants in the retirement plan. The enrollment module 16 also provides the users with the facility of performing certain operations including, but not restricted to setting up the access password, entering the personal information, confirming the contribution rate, selecting the amount of investment and the like. The enrollment module 16 also provides the retirement plan administrators or sponsors with the option of initiating automatic enrollment of eligible users identified and listed by the eligibility module 14. The enrollment module 16 automatically enrolls those eligible users who by themselves have not enrolled to any of the retirement plans (users not having enrolled onto any of the available retirement plans) within the time period available for enrollment. The automatic enrollment carried out by the enrollment module 16 is administered by the retirement plan administrator or sponsors. The enrollment module 16 also sends personalized enrollment confirmations to all the users who get enrolled to the plan either on their own or through the process of automatic enrollment.

The system 10, in accordance with the present disclosure, further includes updating means denoted by the reference numeral 18. The updating means 18 is utilized to update at least the payroll information available within the system 10 which includes at least loans obtained by a user, monetary contributions provided by the employer, compensations received by a user, user's access password, personal information, names of beneficiaries, user's and employer's monthly contribution rate, and amount of investment. The user who has enrolled onto a retirement plan is also provided with the option of editing his/her beneficiary list. The user can add or delete beneficiaries from the corresponding beneficiary list. When the payroll information is altered using the updating means 18, an email notification detailing the alterations is automatically sent by the updating means 18 to the concerned user as well as the concerned plan administrator/sponsor. In case if an organization wishes to enroll its employees for a retirement plan, it can do so by uploading a CSV (Comma Separated Value) file which includes relevant but bulk data that corresponds to the entire workforce of the organization.

The system 10, in accordance with the present disclosure, includes a transfer module denoted by the reference numeral 20 which provides the registered users of the system 10 with the option of transferring the money invested on a particular investment option in a particular retirement plan to other investment options provided within the same retirement plan. The transfer of investment is permitted only if the transfer of investments is in compliance with the rules corresponding to the current retirement plan. The user is also provided with an option of either transferring the existing monetary investment to other investment options available within the same retirement plan or reallocating the monetary investment within the existing retirement plan or rebalancing the current investment within the existing retirement plan.

The system 10, in accordance with the present disclosure further includes a user interface 22. The user interface 22 cooperates with the updating means 18 to receive and display the updated user payroll information. The user interface 22 is also adapted to display the user payroll profile that is generated by the profile creator 12A. The user interface 22 cooperates with the payroll module 12 to receive and display the payroll profiles corresponding to the users. The user interface 22 is also adopted to display the list of eligible users identified by the eligibility module 14. The user interface 22 cooperates with the eligibility module 14 to receive and display the list of eligible users who were identified by the eligibility module 14. The display module 20 is further adapted to display the summary of the account owned by the user. The account summary displayed by the user interface 22 includes data corresponding to at least investment wise transaction details, source wise transaction details, pending transaction details, account balance details, completed transaction details and performance details corresponding to the investment. The user interface 22 also displays user related information including, but not restricted to user name, designation, user payroll information, user contribution details and investment allocation details. The user interface 22 is further adapted to display the plan summary corresponding to the retirement plan selected by a particular user, which includes the amount invested on the retirement plan.

The system 100, in accordance with the present disclosure includes a database (not shown in figures) which is adapted to store at least the payroll information and authentication credentials corresponding to the users. The authentication credentials and the payroll information are typically stored in an encrypted format in order to ensure security of the information. The payroll module 12 cooperates with the database in order to receive the payroll information corresponding to the users. Typically the customizable validation rules and the eligibility rules are also stored in the database. The eligibility module 14 cooperates with the database in order to receive the eligibility rules and accordingly determine whether the users are eligible to avail any of the configured retirement plans. The database, in accordance with the present disclosure also stores the information including but not restricted to beneficiary lists corresponding to retirement plans, user information, user account summary, investment details, transaction history, retirement plan details, contribution details, retirement plan wise investment details and performance of the investment for a particular plan.

In accordance with the present disclosure, the user interface 22 of the system displays a dashboard to retirement plan sponsors and administrators. The dashboard is typically displayed on the ‘Home Page’ of respective Plan Sponsors and Administrators. The Dashboard contains a plurality of placeholders which in turn hold different types of information (including at least static information and dynamic information). These information sets include but are not restricted to to-do lists, alerts and general information corresponding to retirement plans. The dashboard can also contain dynamic links and information customized according to the needs of plan sponsors/administrators. All the transactions performed on the dashboard are recorded and stored in the form of tables in the database. The system 100 makes use of a generic software program which is invoked from all the methods under execution in order to track, record the transactions performed on the dashboard displayed to plan sponsors/administrators.

In accordance with the present disclosure, the system 100 further includes a notes manager (not shown in figures) which enables the user to make notes for every transaction he performs on the system 100. On every webpage displayed on the user interface 22 there is provided a link which invokes a text area with previous notes, if any. The text area is invoked from a master page that acts as a central place where changes to the notes created by users, if any, get registered. Using notes manager, users can add new note as well as update previous notes. All the notes created by the users are stored in the database along with the object ID, user ID and other relevant user information. The notes created by users can either be private or public. Private notes are visible to only the user who created the note whereas public notes are visible to the all users working on that particular object.

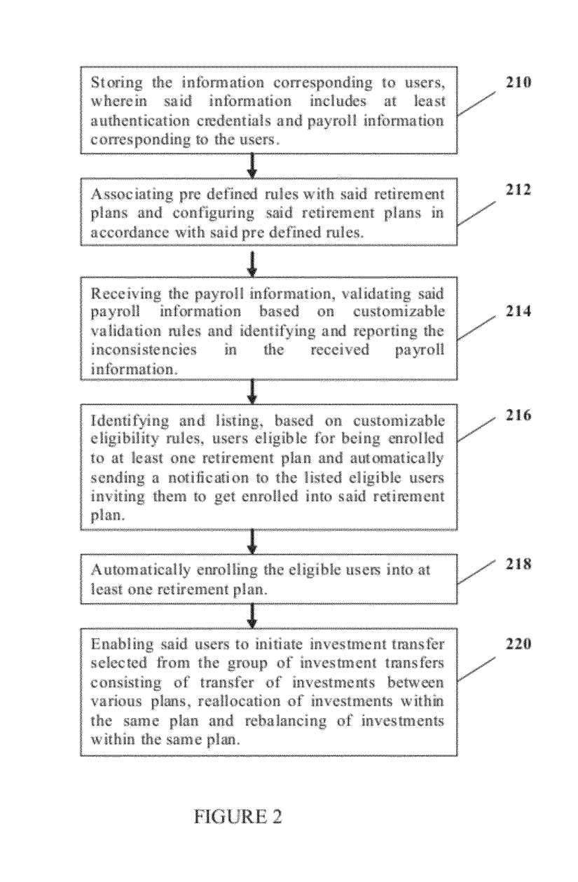

Referring to FIG. 2, there is provided a flowchart detailing the steps involved in the method for facilitating aggregating, analyzing, and distributing of information corresponding to retirement plans offered to users. The method, in accordance with the present disclosure includes the following steps:

storing the information corresponding to users, wherein said information includes at least authentication credentials and payroll information corresponding to the users 210;

associating pre defined rules with said retirement plans and configuring said retirement plans in accordance with said pre defined rules 212;

receiving the payroll information, validating said payroll information based on customizable validation rules and identifying and reporting the inconsistencies in the received payroll information 214;

identifying and listing, based on customizable eligibility rules, users eligible for being enrolled to at least one retirement plan and automatically sending a notification to the listed eligible users inviting them to get enrolled into said retirement plan 216;

automatically enrolling the eligible users into at least one retirement plan 218; and

enabling said users to initiate investment transfer selected from the group of investment transfers consisting of transfer of investments between various plans, reallocation of investments within the same plan and rebalancing of investments within the same plan 220.

In accordance with the present disclosure, the step of storing the information corresponding to users in an encrypted format further includes the step of storing at least pre defined configuration rules, eligibility rules, list of eligible users, employee details and user investment details.

In accordance with the present disclosure, the step of receiving the payroll information further includes the step of creating payroll profiles corresponding to each of the users.

In accordance with the present disclosure, the step of identifying and listing, based on customizable eligibility rules, users eligible for being enrolled to at least one retirement plan further includes the step of generating interlinked summary reports and detailed reports corresponding to the users.

In accordance with the present disclosure, the step of automatically enrolling the eligible users further includes the step of automatically transmitting a personalized enrollment confirmation to the users enrolled onto the retirement plan.

In accordance with the present disclosure, the method further includes the steps of optionally updating the payroll profiles corresponding to the users and optionally modifying the beneficiary lists corresponding to the retirement plans enrolled onto by the users.

In accordance with the present disclosure, the method includes the step of performing certificate based authentication to verify authentication credentials of the users.

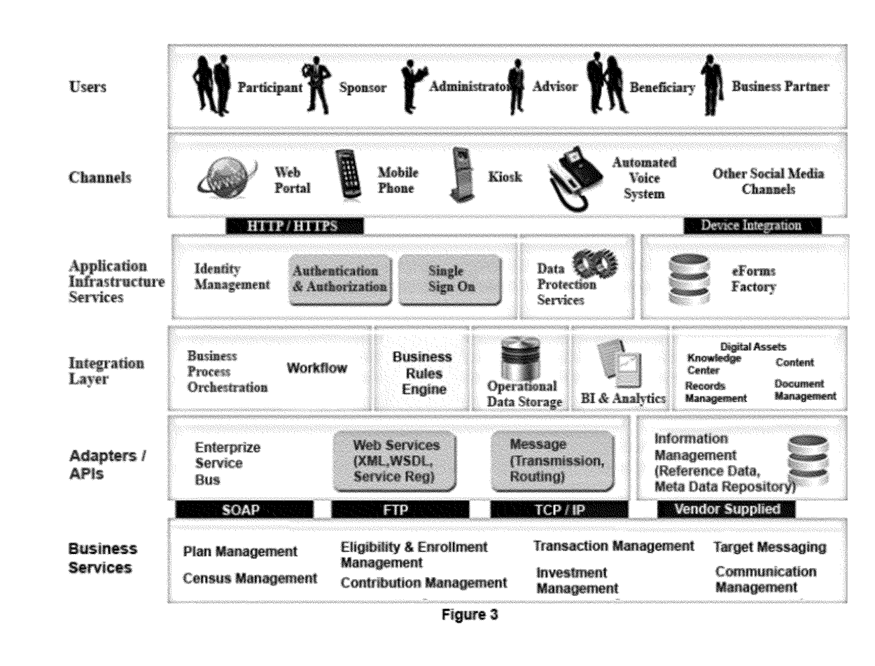

Referring to FIG. 3, there is shown a schematic representation of the components of the system 100 for aggregating, analyzing, and distributing information corresponding to retirement plans offered to users. The “users” column in FIG. 3 denotes the stakeholders of the system 100. The stakeholders of the system 100 include the participant (users who enroll for the retirement plan), sponsors (typically, the employer who offers retirement benefits to their employees), administrator (the organization/individual who takes care of the formalities corresponding to providing retirement benefits to users and administers the plans enrolled onto, by users), advisor (typically, third party advisors who advise users in respect of retirement plans), beneficiary or beneficiaries (typically, the people nominated by the users enrolling onto the retirement plan) and business partner.

The second level, in the architectural overview, as described in FIG. 3 involves the “channels” that could be utilized to access the system 100. In accordance with the present disclosure, all of the aforementioned stakeholders can access the system 100 using either a web portal, a GPRS enabled mobile phone (including iphone), a computerized kiosk, an automated voice system or any other relevant social media channels. The communication between the aforementioned ‘channels’ and the ‘stakeholders’ takes place via protocols including HTTP (Hypertext Transfer Protocol) or HTTPS (Hypertext Text Transfer Protocol Secured). The third level of the architecture of the system 100 includes “application infrastructure services”, which includes an identity management system. The task of the identity management system is to authenticate and authorize the stakeholders of the system based on the authentication credentials which typically include at least a username and a password. The application infrastructure component further includes a ‘single sign on’ system which, through device integration enables the stakeholders to log on to the system 100 using a single set of authentication credentials and through a single log-in process across multiple channels of communication which have been described in the “channels” section. The “application infrastructure services” component further includes ‘data protection services’ which ensure the safety of the information (at least the payroll information, retirement plan related information and authentication credentials corresponding to the users) by storing the information in an encrypted format and by preventing unauthorized users from having access to the information. The “application infrastructure services” component further includes an “eforms factory” which generates all the necessary forms to be utilized by the stakeholders of the system 100. The eforms factory makes use of the concept of device integration to make the necessary forms available across the multiple channels of communication subsequent to a single log-in process initiated by the stakeholders of the system 100.

The system 100 needs to communicate with various user groups at various points in time for a multitude of reasons. To enable these interactions, the system 100 has been adapted to enable stakeholders receive information not only from the system but also from other stakeholders. The system's API includes a message center that is used for communicating throughout the platform. The message center is used to send email and intranet messages. The message center posts the data into the database for mailing. A windows service then reads the data posted by the message center and initiates a mailing system to send the mail. Schedules for the mailing service can be adjusted by an administrator. The system 100 also has the ability to send messages to users through the intranet. To achieve this, the message center posts the data into a specified table which then gets reflected in the relevant stakeholder's home page. The system 100, through the message center provides error messages that make it easy for the users to identify the occurrence of errors, if any and undertake the necessary preventive action. Every occurrence of exception/error is routed to the user in the form of a message. The messages are typically routed in the form of emails. The APIs of the system 100 further include an information management system which holds the reference data required by the stakeholders (data including but not restricted to stakeholder information, information corresponding to occurrence of errors) and also the corresponding metadata.

In accordance with the present disclosure, the architecture of the system 100 as described in FIG. 3 further includes an integration layer. The integration layer includes customized workflows which are managed via a business rules engine which is adapted to determine the course of business workflow of the system 100. The business rules engine is utilized to execute several rules that govern the working of the system 100. For example, the business workflow engine executes the validation rules for validating the payroll information corresponding to the users. The business workflow engine, for example, also executes the eligibility rules for identifying the users who are eligible for obtaining a retirement plan. The business rules engine also provides for the business rules to be modified, if necessary. The integration layer further includes an operational data storage which acts as a repository and holds all the necessary business/operational data including but not restricted to user payroll information, retirement plan related information and eligibility information. The integration layer further includes a BI (Business Intelligence) and analytics engine which takes provides all the necessary analytics corresponding to the stakeholders. The ‘digital assets’ of the integration layer include a knowledge center, records management system which manages the records corresponding to the stakeholders, document management system which all the documents received by/to be provided to the stakeholders of the system. The fourth component of the system are “Adapters/application Programmer Interfaces (APIs) which include web services such as XML(Extensible Markup Language) and WSDL (Web Services Definition Language) which are typically utilized to facilitate communication between the system 100 and the various stakeholders of the system. The APIs of the system further include a messaging system which typically facilitates communication between the system 100 and stakeholders and also the communication between the various stakeholders via transmission/routing of messages.

In FIG. 3, the bottom most layer, includes the component termed “business services” which involves the working components (described in FIG. 1) of the system 100. The working components described in FIG. 3 are merely representative and it is possible to add/delete the components from the architecture of the system 100 without departing from the scope of the disclosure. The working components of the system 100 interact with one another using communication protocols selected from the group of protocols consisting of SOAP (Simple Object Access Protocol), TCP/IP (Transmission Control Protocol/Internet Protocol) and FTP (File Transfer Protocol).

### Technical Advancements

The technical advancements of the present disclosure include:
providing a system that implements a web based self service platform;
providing a system that captures the necessary information at the source without loosing the control over the process of capturing the information;
envisaging a system that provides highly automated business processes;
making available a system that provides customizable plan templates and customizable work flow structures;
providing a system that ensures data concurrency by isolating the transactions performed on the stored data; and
providing a system that makes use of caching to ensure that the data is stored as close as possible to the data consumer.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

The use of the expression “at least” or “at least one” suggests the use of one or more elements or ingredients or quantities, as the use may be in the embodiment of the invention to achieve one or more of the desired objects or results.

Any discussion of documents, acts, materials, devices, articles or the like that has been included in this specification is solely for the purpose of providing a context for the invention. It is not to be taken as an admission that any or all of these matters form part of the prior art base or were common general knowledge in the field relevant to the invention as it existed anywhere before the priority date of this application.

While considerable emphasis has been placed herein on the particular features of this invention, it will be appreciated that various modifications can be made, and that many changes can be made in the preferred embodiment without departing from the principles of the invention. These and other modifications in the nature of the invention or the preferred embodiments will be apparent to those skilled in the art from the disclosure herein, whereby it is to be distinctly understood that the foregoing descriptive matter is to be interpreted merely as illustrative of the invention and not as a limitation.

1. A computer implemented system for aggregating, analyzing, and distributing information corresponding to retirement plans offered to users, said system comprising:
a database adapted to store the information corresponding to users, wherein said information includes at least authentication credentials and payroll information;
configuration module having pre defined rules and adapted to configure said retirement plans and associate said pre defined rules with said retirement plans;
payroll module adapted to receive said payroll information, said payroll module having customizable validation rules for validating said payroll information, said payroll module adapted to identify and report inconsistencies in received payroll information, said payroll module include a profile creator adapted to create payroll profiles corresponding to each of said users;
eligibility module having customizable eligibility rules for identifying and listing users eligible for being enrolled in at least one retirement plan, said eligibility module further adapted to automatically send a notification to listed eligible users inviting them to get enrolled into said retirement plan;
enrollment module adapted to automatically enroll the eligible users into at least one retirement plan; and
transfer module adapted to enable said users to initiate investment transfer selected from the group of investment transfers consisting of transfer of investments between various plans, reallocation of investments within the same plan and rebalancing of investments within the same plan.

2. The system as claimed in claim 1, wherein said system further includes updating means adapted to periodically update the payroll profiles corresponding to said users, said updating means further adapted to facilitate modification of at least beneficiary lists corresponding to retirement plans.

3. The system as claimed in claim 1, wherein said database is further adapted to store at least said pre defined configuration rules, eligibility rules, list of eligible users, employee details and user investment details.

4. The system as claimed in claim 1, wherein said eligibility module is further adapted to generate summary reports having at least the payroll details corresponding to eligible users, and detailed reports, said eligibility module further adapted to interlink said summary reports with said detailed reports.

5. The system as claimed in claim 1, wherein said enrollment module is adapted to automatically transmit a personalized enrollment confirmation to the users enrolled into said retirement plans.

6. The system as claimed in claim 1, wherein said system includes a user interface adapted to display the items selected from the group of items consisting of at least payroll profiles, beneficiary lists, user information, user account summary, investment details, transaction history, retirement plan details, contribution details, retirement plan wise investment details and performance of the investment for a particular plan.

7. The system as claimed in claim 1, wherein said system further includes authentication means cooperating with said database and having pre defined authentication rules and adapted to perform certificate based authentication to verify authentication credentials of the users.

8. A computer implemented method for aggregating, analyzing, distributing information corresponding to retirement plans offered to users, said method comprising the following steps:
storing the information corresponding to users, wherein said information includes at least authentication credentials and payroll information corresponding to said users;
associating pre defined rules with said retirement plans and configuring said retirement plans in accordance with said pre defined rules;
receiving the payroll information, validating said payroll information based on customizable validation rules and identifying and reporting the inconsistencies in the received payroll information;
identifying and listing, based on customizable eligibility rules, users eligible for being enrolled to at least one retirement plan and automatically sending a notification to the listed eligible users inviting them to get enrolled into said retirement plan;
automatically enrolling the eligible users into at least one retirement plan; and
enabling said users to initiate investment transfer selected from the group of investment transfers consisting of transfer of investments between various plans, reallocation of investments within the same plan and rebalancing of investments within the same plan.

9. The method as claimed in claim 8, wherein the step of storing the information corresponding to users in an encrypted format further includes the step of storing at least pre defined configuration rules, eligibility rules, list of eligible users, user information and user investment details.

10. The method as claimed in claim 8, wherein the step of receiving the payroll information further includes the step of creating payroll profiles corresponding to each of said users.

11. The method as claimed in claim 8, wherein the step of identifying and listing, based on customizable eligibility rules, users eligible for being enrolled to at least one retirement plan further includes the step of generating interlinked summary reports and detailed reports corresponding to said users.

12. The method as claimed in claim 8, wherein the step of automatically enrolling the eligible users further includes the step of automatically transmitting a personalized enrollment confirmation to the users enrolled onto said retirement plan.

13. The method as claimed in claim 8, wherein the method further includes the steps of optionally updating the payroll profiles corresponding to the users and optionally modifying the beneficiary lists corresponding to said retirement plans enrolled onto by said users.

14. The method as claimed in claim 8, wherein the method includes the step of performing certificate based authentication to verify authentication credentials of said users.
